(19) United States
(12) Patent Application Publication
(10) Pub. No.: US 2023/0337595 A1
(43) Pub. Date: Oct. 26, 2023

(54) SYSTEM AND METHOD FOR UTILIZING WASTE ENERGY TO PRODUCE PLANTS AND ANIMALS

(71) Applicant: JONATHAN KARL BILY, SURREY (CA)

(72) Inventor: JONATHAN KARL BILY, SURREY (CA)

(21) Appl. No.: 17/728,307

(22) Filed: Apr. 25, 2022

(51) Int. Cl. A01G 7/04; H02S 10/10; H02S 10/40

(52) U.S. Cl. CPC A01G 7/045; H02S 10/10; H02S 10/40

(57) ABSTRACT

This invention relates generally to the production of plants (1), animals (6), and cryptocurrency mining (27) from the use of waste heat (32), electricity, steam (61), and flammable gas (42) from a geothermal source, crude oil rig (46), a biogas facility (67), or any other source of wasted energy such as an industrial process. The invention further relates to an artificial light moving system (58) used within an enclosed growing environment (1), designed to automatically position (78) artificial lights over the plant canopy.

### TECHNICAL FIELD

This invention relates generally to the production of plants, animals, and cryptocurrency from the use of waste heat, electricity, steam, and flammable gas from a geothermal source, crude oil rig, a biogas facility, or any other source of wasted energy such as an industrial process. The invention further relates to the distribution of the plants and animals to the local market for consumption, thereby offsetting the carbon footprint caused by fuel or energy usage from the importation of plants and animals during the winter months. The invention further relates to an artificial light moving system used within an enclosed growing environment. The invention also relates to an automatic hydrogen peroxide and natural pyrethrum misting system, to control pests in an organic manner that is harmless to humans. The invention also relates to recycling water which precipitates or melts on a greenhouse surface. The invention also relates to a system for cultivating crops in the winter months using automatically deployed insulation, then using the same deployment system to artificially induce a reproductive cycle in photoperiod sensitive plants in the summer. The invention also relates to an apparatus that converts the inconsistent flow of waste gas into light energy to grow plants.

### BACKGROUND OF ART

Conventional Proof-of-Work (POW) cryptocurrency mining is a competition of computer power to solve complex math problems, or in general terms cryptocurrency mining is a race to be the first to crack an encryption code. A mining operation using twice as much computer processor power as another will solve a code on average twice as fast as the mining operation with half the relative computer power. Each time a cryptocurrency miner solves a puzzle, that respective miner is usually rewarded in the form of cryptocurrency coins. The process also involves validating data blocks and adding transaction records within the data blocks to a public record/ledger known as a blockchain, in a system known as a consensus mechanism. Meaning generally, the majority of miners or nodes must agree that a particular transaction is valid, thus the system is very difficult to impossible to corrupt or succumb to nefarious activity. This author in another invention of a cryptocurrency called a carbon coin, has proposed a new form of POW which is based on loaning computer power over time. In the new method, the competition is based on amount of computer power loaned and the only puzzles solved are the movement of assets on the blockchain rather than useless puzzle solving.

In Proof-of-Stake (POS) cryptocurrency mining, the creator of the next block is chosen via various combinations such as random selection, wealth, and age. For example, a person holding, submitting in trust, or staking several coins may be selected in a sequence to receive more coins for performing the computer work. The integrity of the system is based on that if a staker is found to have engaged in nefarious activity such as double spending, that staker may lose everything they have staked. POS cryptocurrency systems are far less energy intensive than POW, because there is no competition to solve blocks. Notwithstanding, POS may prove a disadvantage in terms of perceived wealth, as the difficulty of mining POW creates a rarity of commodity similar to gold, or any other precious metals. Billionaire Mark Cuban refers to the phenomenon as “algorithmic scarcity”.

Some examples of cryptographic currencies include Bitcoin, Ethereum, Dogecoin, Litecoin, and Silvercoin. Cryptocurrency coins are now commonly used as a means of monetary exchange all over the world, while some governments such as China, Russia, and India appear in the process of outlawing these decentralized currencies in favour of their own.

The advantage of POW cryptographic currency over paper money is the difficulty at which a cryptographic coin is to create, as cracking codes is essentially the most difficult task a computer can be assigned. A government can mandate printing more money, for example in year 2021 United States president Joe Biden approved a stimulus bill which created around $1.5 trillion dollars of new United States currency. This amount of paper currency is greater than the market cap of Bitcoin at the time of filing this invention, wherein the current total value of Bitcoin is around $1.1 trillion United States dollars (USD). But printing excessive amounts of currency can result in hyper-inflation of prices and the destabilization of a national currency. Venezuela for example, has seen massive inflation since 2016 of 53,798,500% to the time of filing the present invention. Many parts of the world in 2022 are currently in a state of hyper-inflation.

Many forms of POW cryptocurrency cannot simply be “printed”, and thus have an inherent perceived value of scarcity similar to gold. The cryptocurrency Bitcoin (BTC) has a limit of 21 million coins, wherein each subsequent coin is more difficult to produce than the last. Ethereum (ETH) now “burns” or otherwise destroys coins deducted as transaction fees while moving to a POS system, as to maintain scarcity of that particular cryptocurrency system. Further, cryptographic currency cannot be counterfeited because each coin can be instantly verified mathematically using a public blockchain to verify registration of the coin, as well heavy encryption prevents corruption of the transaction system. As such, blockchain technology with adequate numbers of independent miners or nodes has thus far proven to be impervious to computer hackers. Notwithstanding, many experts have predicted that quantum computers will soon be able to crack Bitcoin wallets which are based on the SHA-256 and SHA-512 encryption standards.

One problem with cryptocurrency is the amount of electrical energy require to mine conventional POW cryptocurrency coins, which is now amounting to the energy consumption of entire countries such as Ireland or Argentina. As well, huge amounts of waste heat are being discarded from large cryptocurrency mining facilities. For example, a large publicly traded company in Quebec, Canada, is estimated to consume the equivalent electricity of 25,000 homes. As such, cryptocurrency is widely regarded as having a high carbon footprint and being a “dirty”, unsustainable technology. As well, server farms and other large computer facilities generally waste their heat.

For the sake of obtaining low-cost electricity, some crypto mining operations have been installed in trailers and shipping containers positioned near crude oil wells, where the crude oil well emits substantial amounts of methane known as flare gas. Flare gas is burned and essentially wasted in a flare stack. However, governments have begun to place limits on the amount of flare gas a petroleum company can emit and have also began taxing these emissions. Therefore, a petroleum company is able to save money by allowing crypto currency mining to occur adjacent to a crude oil well. The Russian state oil company is already widely engaged in this practice.

However, there has been public outcry and subsequent media articles from merging two industries which are both widely considered high carbon footprint, wherein a large amount of heat energy is still wasted. Therefore, there is a need to make use of this large amount of waste heat in a productive manner. Further, a petroleum company that is able to utilize waste heat and sequester emitted carbon may earn carbon credits which are worth money.

Northern countries such as Canada must import most of their fresh produce during the winter months and grow a small portion in commercial greenhouses, which are often directly heated by burning natural gas. However, transporting fruits and vegetables from Mexico or California to places such as Nunavut consume large amounts of fuel sometimes far greater than the carbon footprint associated with the production of the fruits and vegetables, therefore having very large carbon footprints per se. Also, according to the Smithsonian Institute, growing an ounce of indoor cannabis can emit as much carbon into the atmosphere as a full tank of gas in an average motor vehicle. Conventional winter greenhouses in Canada heated by natural gas are also widely considered high carbon footprint.

Winter growing of plants possesses an inherent advantage over summer growing in relation to pest control. Since pests usually cannot thrive outside of the growing environment, and generally speaking cannot be drawn in through the ventilation system, pest control is relatively easy in the winter months. Countries such as Iceland are able to completely eliminate the use of chemical pesticides because of the cold outside conditions and strict hygienic practices. But importing foods from Mexico in particular, can be risky in terms of types of pesticides used from a country reputed with poorly enforced regulation. Therefore, there is a need to produce local foods where pesticide use can be closely monitored, and where food can be produced organically at a low cost.

Prawns and/or shrimp are popular foods among many people and are often cultivated in countries such as China, then shipped frozen to overseas buyers. Again, the energy required to freeze, refrigerate, and then transport and store these prawns to their end consumer in a frozen state produces a large carbon footprint in the form or transportation fuel consumption, and electrical energy consumption to operate the refrigeration. Also, Chinese companies are known to produce food in poorly enforced regulation, filthy conditions, where the inherent quality of the prawn is in question. As such, there is a need to locally produce shrimp and preferably eliminate the need to use large amounts of energy to freeze the shrimp.

Also, there is a need to combine the technologies of winter greenhouse/indoor plant growing and shrimp cultivation with cryptocurrency mining, while utilizing in two examples, a crude oil well or biogas facility as a source of heat and electrical energy that would otherwise be wasted.

Cryptocurrency mining produces a large amount of heat due to continuous operations, which requires the need for substantial cooling systems to prevent the computer circuitry from overheating. In most circumstances, many fans are used to remove heat from the computer circuitry. But air is a poor conductor of heat and has an inherently low thermal capacity. As such, large amounts of air circulation via fans must be utilized, and ideally cold air must be provided. Oppositely, liquids are much more efficient at removing heat and thus an efficient liquid cooled system is needed for transferring heat energy from the cryptocurrency mining equipment to the deep winter greenhouse. Water for only one example, conducts heat approximately 30 times faster than air.

Conventional light moving systems have been used for some time. These systems allow for a larger growing area than stationary lights, and a more even distribution of plant growth. Conventional light moving systems either operate on a track which moves the light back and forth, or in a rotating circle. However, these systems are designed for high intensity discharge lights (HID), which are compact and bright in comparison to newer light emitting diode (LED) lights which are often large panels. Further, conventional light movers require manual adjustment as the plants grow, and do not adjust themselves into angles. The effectiveness of artificial lights is dependent upon keeping the artificial lights close to the plants, to minimize light bleed and maximize light intensity. Therefore, there is a need for more sophisticated light moving systems which can automatically deploy, and automatically adjust themselves as the plants grow in a modern LED based greenhouse.

### SUMMARY OF THE INVENTION

A commercial greenhouse or enclosed growing environment may be constructed near a crude oil well, geothermal site, or a commercial biogas facility. The greenhouse may be positioned lengthwise in an east to west direction, to maximize the amount of sunlight the plants receive during the day. The greenhouse may have supplemental artificial lighting to extend the daylight hours of the plant growth or increase the intensity of the light delivered to the plants. Alternatively, an enclosed growing environment may be insulated from the outside and may not allow the sun's rays to pass through the walls.

An anaerobic digester may be used to decompose organic waste material into methane, wherein the methane may be combusted in an internal combustion engine or gas turbine which turns a generator to generate electricity. The methane may alternatively be used in a fuel cell to generate electricity. Decomposed organic material from an anaerobic digester may be used to fertilize the plants grown in the greenhouse. The waste heat from the anaerobic digester and the electrical generation may be used to heat the greenhouse. The heat may be stored in a heat sink positioned below the greenhouse.

Waste carbon dioxide from an anaerobic digester, a generator motor, or carbon dioxide filtered from the raw flare gas may be directed into the greenhouse to provide carbon dioxide enrichment for the plants. The waste gas may be filtered of impurities such as hydrocarbons before being directed into the greenhouse. A sensor may be used to maintain a consistent level of carbon dioxide in the greenhouse, such as a range of 1500-2000 parts per million (PPM). A solenoid valve may be connected to the carbon dioxide sensor and the source of carbon dioxide, to control the level of carbon dioxide in the greenhouse. Alternatively, for this document any type of valve may be used to regulate a flow of carbon dioxide into the greenhouse. Valves may also be ball, butterfly, diaphragm, globe, needle, pinch, plug valves, safety relief valves, pressure release and vacuum relief valves, non-return valves, swing check and lift check valves.

The greenhouse may be comprised of insulation around and on the bottom of the greenhouse foundation. The greenhouse foundation may be filled with rocks, ceramic pieces, insoluble salt chunks, gravel, metal, or any other non-toxic heat absorbing material. The heat absorbing material may have a high thermal capacity and act as a heat sink. Heat from the cryptocurrency mining equipment may be directed onto the heat absorbing material within the heat sink. Steam from the crude oil rig which pumps oil out of the well may be directed onto the heat absorbing material within the heat sink, after the steam may be used in a turbine to generate electricity. In addition, the greenhouse heatsink may serve as a condenser for the turbine, which may increase the conversion to electricity. A bypass valve controlled by a thermostat may be connected to the steam line to exhaust the steam if the heat sink becomes too hot. The steam may be redirected by on/off valves to an auxiliary heat sink if the primary heat sink becomes too hot.

Water used to irrigate the plants or animals may come from a water well, a stream, a river, a lake, condensation, atmospheric precipitation, or any body of water. The water may be filtered of impurities by example of reverse osmosis, charcoal filter, zeolite filter, particle filter, ion filter, or by any known means of filtration. Snow or ice may be collected by a front-end loader and dumped into a hopper. Waste heat from the cryptocurrency mining equipment may be used to melt the ice or snow into water. Waste heat from steam, a crude oil rig, or any other source may be used to melt ice or snow into water. The water may subsequently be used to irrigate the plants. Also, may types of plants have a high percentage of organic waste that humans do not consume, for example only the fruit of a tomato plant may be used. However, the foliage of the tomato plant or any other organic material may ground or cut up, dried, compressed into pellets, then fed to the prawns/shrimp, fish, or whatever animals are being cultivated. In this way, the system is not wasteful by utilizing all waste organic mass. The plant foliage may also be combined with vitamins, growth stimulants, or other sources of carbohydrates, fats, and proteins.

A potential hydrogen (pH) monitoring system may be employed, as pH tends to fluctuate with plant and animal growth when nutrients are either added or depleted. These pH monitoring systems may often automatically introduce solutions and buffers into the water, as to maintain a relatively constant pH. Most plants and animals thrive in a freshwater pH of 5.8 to 6.7, but other ranges may be used in exceptional circumstances.

A greenhouse operating in the winter may lose heat rapidly at night and may require additional heating. As such, it may be practical to store heat in a heat sink for use at night, or whenever the greenhouse falls in temperature. The heat sink may be further comprised of a reservoir to store water. The reservoir and heat sink may be located underneath or otherwise below the greenhouse. Alternatively, the reservoir may be located beside the greenhouse or above ground. The reservoir and heat sink may be insulated to minimize loss of heat. The reservoir may have a pump to draw water to the greenhouse to irrigate the plants. Air ducting may be positioned through the heat sink and reservoir to circulate air through. The air ducting may further have fins similar to a radiator to facilitate conduction of heat. A fan may be connected to the ducting. A thermostat may be connected to the fan. Warm air may be circulated from the heat sink to the greenhouse to regulate the temperature of the greenhouse. The reservoir may have fertilizer dissolved in the water, as to provide a large source of nutrients and water for a hydroponic system.

Steam is often produced on a crude oil rig associated with a crude oil well and the steam may also be used as a source of energy. Pressure from the steam may be used to generate electricity through a generator apparatus such as a steam turbine mechanically connected to a generator, and the electricity may be used to power the greenhouse, artificial lighting, and/or cryptocurrency mining equipment. The electricity generated during the day may be stored in a battery, wherefrom the electricity is used in the evening to power artificial lighting, pumps, fans, etc. Further, waste heat from electrical generation, such as heat from an engine exhaust or exhaust of a gas turbine, may also be used to generate steam. The steam may be used to turn an electrical generator and generate electricity. In turn, the waste steam can then be injected into the greenhouse reservoir to recycle the water and utilize the remaining heat. Such an application may utilize nearly all of the available energy within the flare gas or other source of waste energy. A bypass valve may be connected to the steam line and controlled by a thermostat located within the heat sink and/or reservoir, wherein the bypass valve may open and release steam into the atmosphere to prevent the heat sink/reservoir from overheating. The water in the greenhouse reservoir may be circulated into the condenser of a steam turbine, as to increase electrical generation and further utilize waste heat.

Water sources can be difficult to access on crude oil well sites, as the site is often located in remote areas. Waste heat from electrical generation, steam from the crude oil rig or other sources, and waste heat from the cryptocurrency equipment may be directed onto collected rain. Rain may be collected with an open top collection area or may be deposited by equipment into a collection area. The water may be directed into a reservoir and used to irrigate plants grown in the greenhouse or provide an aquatic environment for shrimp, fish, shellfish, or other aquatic animals. The reservoir may comprise a portion of the heat sink or may encompass the entire heat sink. Waste produced by the fish or shrimp/prawns may be circulated through the solid portion of the heat sink such as rock chunks, wherein aerobic bacteria may populate the surface of the heat sink material, and the bacteria may break the waste down into raw chemical salts such a nitrates and phosphates. The heat sink material may be highly porous and comprised of irregular shapes, to provide a large amount of surface area for bacterial growth. The water containing these decomposed mineral salts may then be used to irrigate plants in the greenhouse or may be used to supplement or be combined with a hydroponic fertilizer solution.

The greenhouse may inherently lose the most amount of heat through material where sunlight passes through. The greenhouse may be comprised of glass or plastic panels. The greenhouse may be comprised of sheets of plastic. The greenhouse may be comprised of multiple layers of panels, or bubbles or pockets of a heat insulating gas. Heat insulating gases may be also be referred to as greenhouse gases. Dual panels may be installed to pass light and a vacuum may exist between the panels to minimize conduction of electricity.

For the purpose of the present invention, greenhouse gases are any type of gas which reflects infrared energy. Greenhouse gases may also provide poor conduction of heat. Such gases by example may be methane, carbon dioxide, argon, neon, or any inert gas may be included in the definition of a greenhouse gas, including any mixture of gases.

To maximize the insulating properties of the greenhouse, an insulating greenhouse gas may be injected in between glass or plastic panels. Further, plastic bubble wrapping may be used to insulate the greenhouse. The bubble wrapping may contain a greenhouse/insulating gas to minimize the loss of heat from the greenhouse. The plastic may possess a high degree of ability to transmit blue, violet, and ultraviolet light. Panels may be installed which have a vacuum between the plastic or glass sheets.

To further maximize the insulating properties of the greenhouse, automatic shades may be drawn at night over the greenhouse to further limit heat loss. Automatic shade systems may also be used during the day to artificially induce flowering from plant species that are sensitive to photoperiod. Alternatively, when heat needs to be exhausted from the invention, an environmental control system may control the automatic shades by raising them to facilitate heat loss.

Moisture will naturally condense or melt on the clear greenhouse surface, both on the inside and outside of the structure as a result of outside precipitation and inside moisture condensation. The melting of water may occur from the sun's rays heating the greenhouse during the day. Troughs may be positioned on the inside and outside of the greenhouse at or near the base of the greenhouse, to collect condensed or melted water. The melted or condensed water may be directed into the reservoir tank or heat sink. The collected water may be used to irrigate plants or be given to animals.

To facilitate cooling of the cryptocurrency mining equipment, liquid cooled computer heat sinks may be physically connected to the integrated circuitry (IC) and related components. Water from the reservoir may be circulated by a pump through the computer heat sinks to transfer the heat from the cryptocurrency mining equipment to the water reservoir. Alternatively, a heat exchanger may be positioned within the water reservoir and a coolant may be circulated by a pump between the integrated circuitry and the water reservoir. As another alternative, a heat pump may circulate a refrigerant between a condenser located in the water reservoir or elsewhere within the greenhouse, to the integrated circuitry and other components of the cryptocurrency mining equipment. Alternatively, the cryptocurrency mining equipment may be located within the greenhouse to heat the greenhouse. As another alternative, the cryptocurrency mining equipment may be submerged in an electrically non-conductive fluid such as mineral oil, and the mineral oil may be circulated by a pump to a heat exchanger located within the greenhouse, water reservoir, or greenhouse heat sink. Any fluid which does not conduct electricity and is suitable for cryptocurrency mining may be known as a nonionic fluid. A heat pump may be used for cooling during the summer months. The heat may be moved by heat pump into the ground.

The greenhouse plants may require supplemental artificial lighting. Light emitting diode (LED) lighting is currently among the most efficient artificial lighting, but fluorescent and high intensity discharge lighting (HID) may also be used in a greenhouse. Light movers are well known within greenhouses and indoor grow rooms, as to maximize the growing space and allow light to penetrate at different angles into the plants. Conventional light movers either move the light fixtures in a circle, or back and forth on a track.

Conventional light movers suffer from the limitation of not always being able to obtain the ideal distance from plants, especially when plants are of varying height or located on tiered platforms of varying height. Also, LED fixtures are quite large compared to HID fixtures and may block a significant amount of sunlight during the day. Light fixtures may therefore be positioned on cables or rope that are retractable. Retractable cables may be on a spool. The spool may be motorized. Alternatively, the spools may be replaced or supplemented with a motorized pulley system. For the scope of the invention, any device which at least one of raises and lowers the artificial lights may be used and may be referred to as a device which at least one of raises or lowers an artificial light. As an alternative, vertically positioned tracks may also be used with some type of motor. The motors used throughout this document may be based on internal combustion, such as with alcohol fuels. Motors may also be alternating current (AC) brushless, direct current (DC) brushed motors, DC brushless, direct drive, linear, servo, stepper, permanent magnet, series DC, shunt, compound, or any other suitable type. The tracks may have teeth or gear grooves, wherein a motor moves up and down. Motors may also utilize compressed gases for power. The cables or rope may have physical properties which allow the conduction of electricity. One cable may be positively charged with electricity while another cable may be negatively charged. A cable may be connected to a neutral, connected to ground, or provide alternating current (AC) to the light fixture.

The light fixture may be equipped with proximity sensors. Proximity sensors may be either passive or active, meaning an active sensor may have a transmitter and receiver. A passive sensor may have only a receiver, such as a pair of cameras that generate slightly different images used to determine distance. A sonar, ultrasonic, radar, light, or laser-based system may be used in an active proximity system to determine distance from the light fixture to the plants. Any type of energy or radiation may be emitted from the transmitter and received by the receiver. The proximity sensor may receive instructions from or provide information to a microprocessor.

For the purpose of this invention, an analog circuit connected from the proximity sensor to the motorized spool may provide voltage or current which causes the spool to maintain the artificial light a predetermined distance from the plants. A digital circuit and/or microprocessor may receive information from the proximity sensor and control the motorized spools, which are one of many devices which at least one of raise and lower artificial lights. The motorized spools may operate continuously as the light fixtures are moved along the track. The lighting system may further be comprised of a photocell or photoresistor. The lighting system may be equipped with a light intensity meter, and for the purpose of this invention a photocell or a photoresistor, or any other photo sensitive electronic device may be referred to as a light intensity meter. Information from the light intensity meter may be used in the lighting system to determine the distance of the artificial lighting from the plants. For one example, high ambient natural lighting during the day may result in the lighting system dispersing light at a greater distance from the plants. Alternatively, high ambient lighting may result in a greater distancing of the light as to not oversaturate the plants with lighting. Photosynthetic efficiency in an average terrestrial plant may be less than 2%. During times of peak output of flare gas, artificial lighting may turn on and off Alternatively, batteries may be utilized to store electrical energy. Batteries may store energy chemically such as lead acid, nickel metal hydride, lithium, or lithium ion, but may also store battery hydraulically such as a gravity based water dam, by pressure, by centrifugal force such as a fly wheel, or energy storage by any other means.

The advantage is the artificial lighting apparatus may deliver a more consistent amount of light to plants being grown. Artificial lighting suffers from the physical disadvantage associated with the inverse square law, wherein light dissipates very quickly from the source. As the sun is about one million times the size of the Earth, natural sunlight does not dissipate rapidly. However, since artificial sources of light are generally quite small, the intensity of light may dissipate rapidly with distance. In a variation of the invention, a fish farm is used as a heat sink and/or water reservoir. In another variation of the invention, livestock such as chickens or pigs are raised utilizing the heat provided from the cryptocurrency mining and waste energy.

A steam turbine may be utilized as a component of the invention, as to convert steam into electrical energy from the use of the steam turbine. Steam turbines may be among three basic types of steam turbine used to generate power as a by-product of process or exhaust steam: condensing, pass-out condensing, and backpressure. The condenser component from the steam turbine may be liquid cooled using the water in the greenhouse reservoir, by utilizing a heat exchanger, a heat pump, or by directly circulating the water from the greenhouse reservoir into the condenser.

During periods of excessive heat, such as in the summer months, water from the greenhouse reservoir may be misted into the greenhouse while the exhaust fans operate. This method of evaporative cooling may rapidly cool the greenhouse and dissipate heat from the heat sink.

Other aspects, embodiments and features of the invention will become apparent from the following detailed description of the invention when considered in conjunction with the accompanying figures. The accompanying figures are for schematic purposes and are not intended to be drawn to scale. In the figures, each identical or substantially similar component that is illustrated in various figures is represented by a single numeral or notation at its initial drawing depiction. For purposes of clarity, not every component is labeled in every figure. Nor is every component of each embodiment of the invention shown where illustration is not necessary to allow those of ordinary skill in the art to understand the invention.

### BRIEF DESCRIPTION OF DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1 is a schematic diagram of a three-dimensional side view of an embodiment of a deep winter greenhouse equipped with a heat sink for storing heat, water, and growing freshwater prawns;

FIG. 2 is a schematic diagram of a three-dimensional side view of an embodiment of a deep winter greenhouse equipped with a heat sink for storing heat and water;

FIG. 3 is a schematic diagram of a three-dimensional view of an embodiment of a greenhouse water collection system;

FIG. 4A is a schematic diagram of a three-dimensional view of an embodiment of an automated night-time insulating system for a greenhouse, depicting the insulation retracted;

FIG. 4B is a schematic diagram of a side view of an embodiment of an automated night-time insulating system for a greenhouse, with the insulation deployed;

FIG. 5 is a schematic diagram of a three-dimensional view of an embodiment of cryptocurrency mining equipment comprised of a liquid cooling system;

FIG. 6 is a schematic diagram of a side view of an embodiment of a flame stack modified to provide flare gas for electrical generation;

FIG. 7 is a schematic diagram of a side view of an embodiment of a collection area designed to collect and melt snow;

FIG. 8A is a schematic diagram of a side view of an embodiment of an automatic artificial light moving system using motorized spools;

FIG. 8B is a schematic diagram of a side view of an embodiment of an automatic artificial lighting system using motorized pulleys;

FIG. 8C is a schematic diagram of a side view of an embodiment of an automatic artificial lighting system in a retracted state;

FIG. 9 is a schematic diagram of a side view of an embodiment of a filtration system for purifying flare gas into methane;

FIG. 10 is a schematic diagram of a side view of an embodiment of a configuration for co-generating electricity and utilizing waste heat;

FIG. 11 is a schematic diagram of a side view of an embodiment of a modified biogas facility designed to utilize generated waste carbon dioxide in a greenhouse;

FIG. 12 is a schematic diagram of a three-dimensional view of an embodiment of a hydrogen peroxide and natural pyrethrum dispensing system;

FIG. 13 is a schematic diagram of a depiction of a geothermal radiator; and

FIG. 14 is a schematic diagram of an overhead view of a concentrated solar system for reflecting light into the greenhouse.

### DETAILED DESCRIPTION OF THE INVENTION

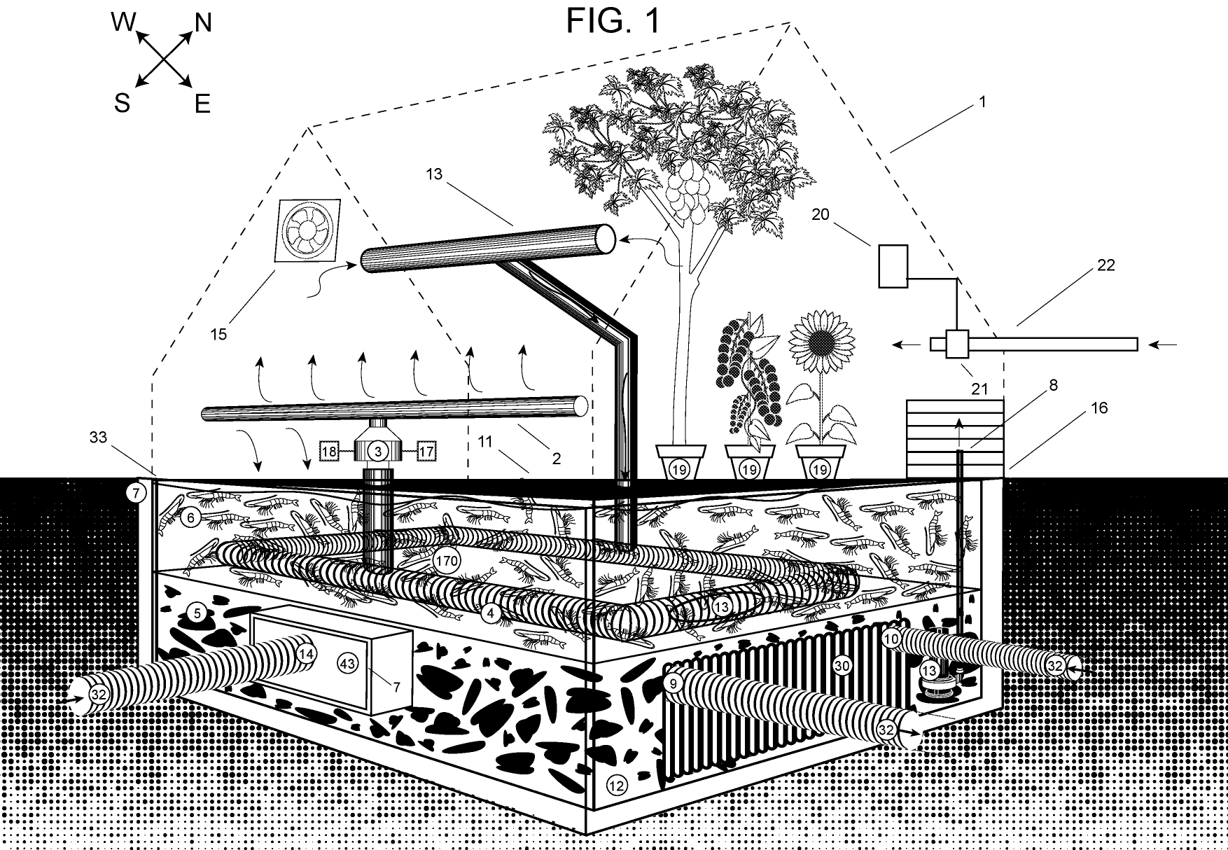

FIG. 1 depicts a greenhouse 1 positioned lengthwise east and west, with a southern exposure to the sun in the northern hemisphere. Alternatively, greenhouse 1 may have a northern exposure to the sun in the southern hemisphere. A greenhouse 1 may be defined as any enclosure configured to retain heat and cultivate plants by passing light through a surface or area of the enclosure. For the purpose of this invention, a greenhouse 1 may also be any indoor environment configured for growing plants. An exhaust manifold is a device of any solid material which may distribute air. A circulation fan 3 may be any type of fan, turbine, or device intended to move air. An exhaust manifold 2 may provide warm air distribution to the greenhouse 1 by a circulation fan 3, wherein metal piping 4 may be positioned underneath the floor 11 and through a bed of irregular shaped rocks 5. Alternatively, any piping, ducting, or conduit which conducts heat may be used instead of metal piping 4. The circulation fan may be controlled by a thermostat 17 or a timer 18. A thermostat may be electrical or mechanical and may be any device which measures temperature. The thermostat 18 may utilize a thermal couple, a thermal resistor, may be use line voltage or low voltage, may use a wireless transmitter, may use fibre optic cable, may be programmable, may provide information to an environmental control system, may use vapour filled bellows or bimetallic strips, or automatic set back. The timer 18 may be mechanical, electrical, analog or digital. The metal piping 4 may connect to an air intake 13 which may be located near the ceiling of the greenhouse 1. An air intake is any type of opening which allows air to flow inwards. Irregular shaped rocks 5 or any other type of solid medium may be contained within a greenhouse reservoir 12 that which may contain a substantial amount of reservoir water 6. The entire greenhouse reservoir 12 may be surrounded by a heavily insulated wall 7 to minimize loss of heat. Insulation may be comprised of natural fiber, fiberglass, a vacuum, greenhouse gases, or any type of substance or material which is a poor heat conductor. Moisture condensing on the bottom of the metal piping 4 may be pumped into the greenhouse reservoir 12 by a submersible pump 13 equipped with a float switch (not shown), or by use of a timer (not shown). A float switch may be any device which engages a circuit when the water level reaches a certain height. A submersible pump 13 may also be substituted with any type of pump, including inline, centrifugal, rotary vane, positive displacement, screw, or axial flow.

Water may be drawn up from the greenhouse reservoir 12 through a vertical tube 8 using a submersible pump 13, or any other type of pump. Alternatively, pressure may be used to push the water upwards, or if the reservoir is located above ground the water may flow by the force of gravity. The vertical tube may be a hose, a pipe, corrugated flexible tubing, a conduit, concrete, rock, epoxy, ceramic, or any other type of suitable material. The vertical tube 8 may also run horizontal for portions of distance. The vertical tube 8 may be comprised of plastic, rubber, metal, or any other type of suitable material. The reservoir may also contain a water input 9 and a water output 10. The reservoir may also contain a steam input 14. The water input 9 and water output 10 may be any type of opening or membrane designed to pass water. The steam input 14 may be any type of opening or membrane designed to pass steam. Membranes may be comprised of any type of suitable material, organic or inorganic. The water drawn from the vertical tube 12 may be used to irrigate plants directly, or the water may be pumped into a hydroponic system wherein the fertilizer is more concentrated. The greenhouse reservoir 12 may also be equipped with a water level sensor 33 which may provide information to a display or an environmental control system (not shown). Water level sensors 33 may be based on electrical conductivity, ultra-sonic, Doppler effect, laser or light, camera, float, radar, sonar, or any other means of determining the amount of water in a greenhouse reservoir. Alternatively, a stick or ruler may be inserted down a shaft, and the water level determined manually by a person or interpreted by a computer.

The greenhouse 1 may also be comprised of an exhaust fan 15 and a shuttered air intake 16. The exhaust fan 15 may exhaust greenhouse air to the outside and the exhaust fan 15 may be connected to and controlled by a thermostat 17 or may be turned on and off by a timer 18. The shuttered air intake 16 may open while the exhaust fan 15 is operating allowing outside air to enter the greenhouse 1, and the shuttered air intake 16 may close when the exhaust fan 15 is not operating to limit air from escaping from the greenhouse. The air intake may also be supplemented or be comprised of an intake fan (not shown). Alternatively, an air intake may not have shutters and may utilize a door that opens or closes, or a slider which opens or closes.

The irregular shaped rocks 5 can be replaced, supplemented, or substituted with a variety of other materials such as porcelain, concrete chunks, metal, gravel, clay pellets, coarse sand, or any other material with a good thermal capacity and large surface area. For the purpose of this document, irregular rocks and other similar materials may be referred to as heat absorbing material.

The irregular shaped rocks 5 may also serve as a filter medium for the cultivation of aquatic animals. These aquatic animals may include shrimp, clams, oysters, crab, shellfish, prawns, fin fish, or any other animal which thrives or otherwise lives in aquatic conditions. The greenhouse reservoir 12 may further be comprised of a growth chamber 170 in which aquatic animals are cultivated in reservoir water 6. Water may be circulated from the growth chamber 170 into the irregular shaped rocks 5 by a submersible pump 13 and then back into the growth chamber 17, as to provide biological filtration of the reservoir water 6. Further, the aquatic animals may provide organic waste which is decomposed by the aerobic bacteria growing on the irregular shaped rocks 5 into raw chemical salts, wherein the reservoir water 6 is then irrigated onto the greenhouse plants 19. FIG. 1 also depicts a heat exchanger 30, which may provide heat from sources such as cryptocurrency mining equipment, that is later discussed.

FIG. 1 also depicts a carbon dioxide monitor 20 which may turn on/off a gas valve 21. The gas valve 21 may be a gate valve, globe valve, check valve, plug valve, ball valve, butterfly valve, slam-shut valve, or any other suitable valve. Carbon dioxide filtered from flare gas, or as a product of combustion may be provided through a carbon dioxide gas line 22. The gas line 22 may be comprised of any type of material including metal, wood, plastic, ceramic, organic material, or inorganic material. Alternatively, carbon dioxide may also be provided from compressed bottle cylinders (not shown). Enriching concentrations of carbon dioxide in the greenhouse may accelerate plant growth and improve yields, while sequestering carbon from the industrial source.

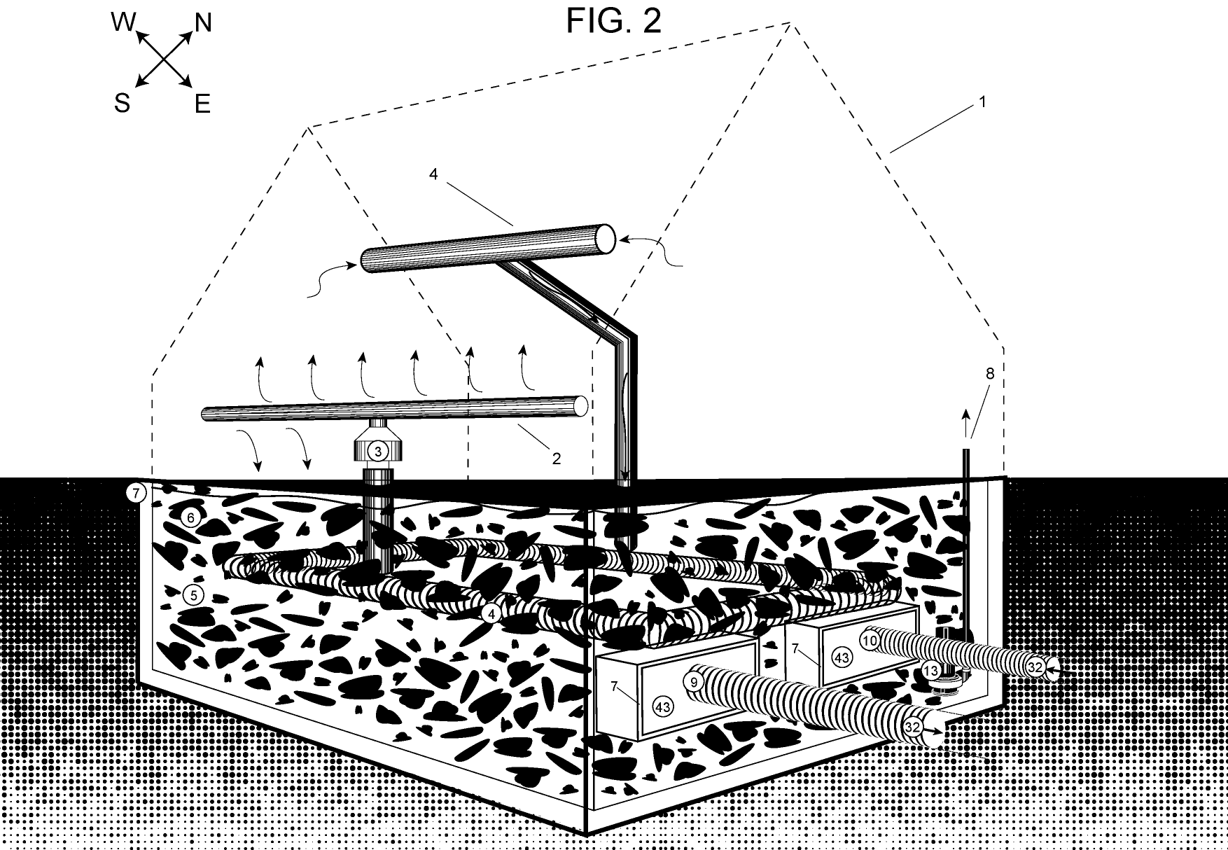

FIG. 2 depicts a variation of the greenhouse which does not include the grow chamber 170. FIG. 2 also depicts water input 10 and water output 9, which may circulate water to heat sources which are later discussed.

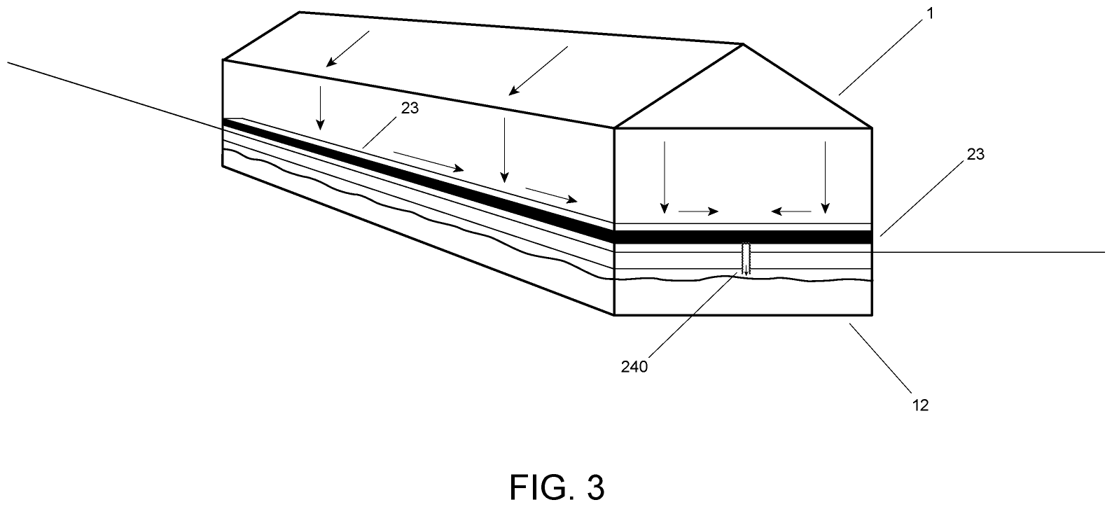

FIG. 3 depicts a greenhouse water collection system designed to collect and utilize outside precipitation and inside condensation. Troughs 23 are positioned on both the inside and outside base of the greenhouse 1. Troughs 23 may be rectangular shaped, curved or a semi-circle, oblong, triangle, or any other shape that collects water droplets by means of gravity. Water droplets may flow from the greenhouse wall surface into the troughs 23 and down a hose 240 into the greenhouse reservoir 12. The hose 240 for be substituted with any type of a tube. Sun rays may heat the greenhouse during the day and cause snow accumulating on the greenhouse walls to melt, as well cooling at night may cause humidity in the air to condense on the greenhouse walls, wherein the water droplets flow downwards by the force of gravity. The troughs 23 may be made of any suitable material including plastic, aluminum, wood, metal, or fiberglass, carbon fibre, carbonates, and the troughs 23 may also be substituted with any solid substance that is angled to collect water.

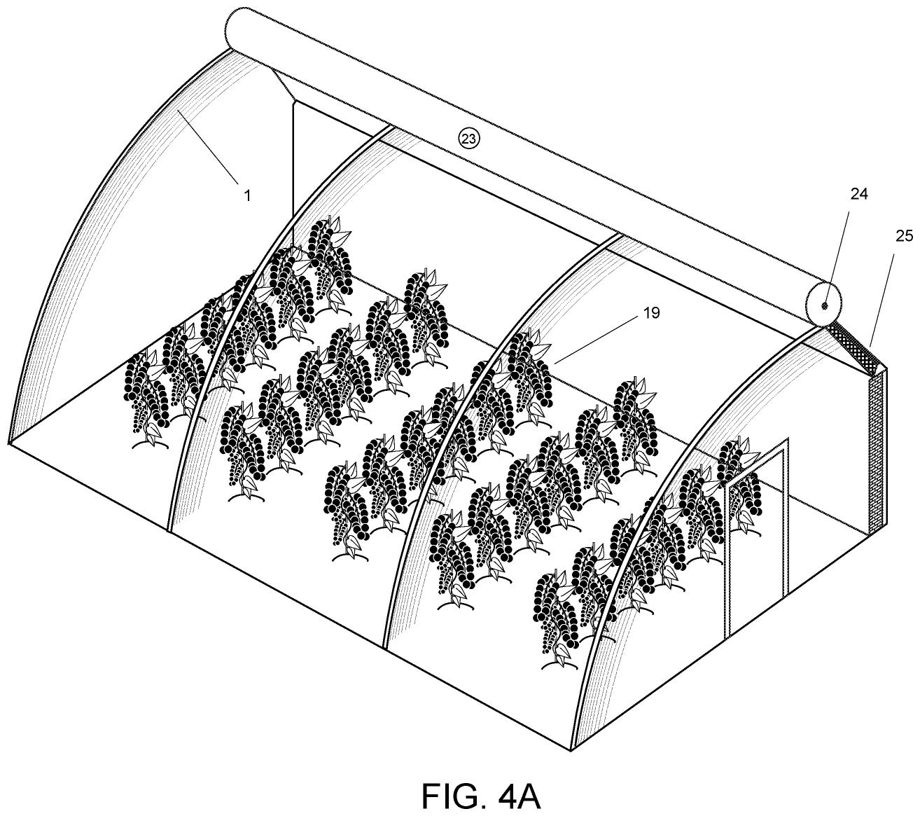

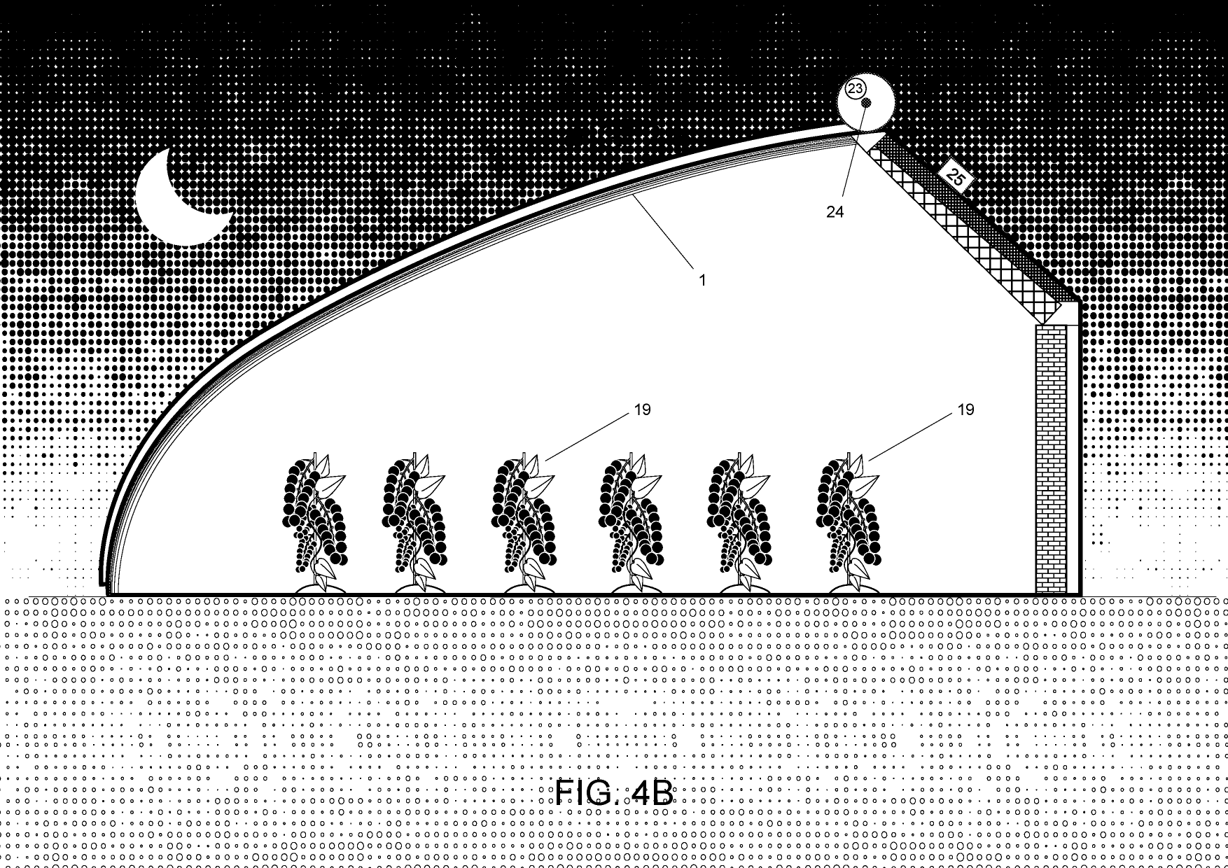

FIG. 4A and FIG. 4B depict a night-time insulating system, which covers the glass or clear plastic areas during the night. Use of such a system may assist in further limiting heat loss. Insulating blankets 23 may be deployed by motorized rollers 24 to cover the walls of the greenhouse. An electronic photosensor 25 may activate motorized roller 24 when the external atmosphere becomes dark, or motorized roller 24 may be activated by a timer (not shown). The photosensor may be a photoresistor, a photocell, photochemical, a photodetector, a photodiode, a voltaic cell that produces electrical current, or any other type of sensor. The photo sensor may detect the heat of the sun as well. As well, the motorized roller 24 may lift and/or retract when the external environment reaches a certain level of light intensity. It should be understood that the timer may be part of a more sophisticated environmental control system, and that environmental control system may be comprised of a microprocessor which makes decisions based on environmental conditions. Further, the insulating blankets 23 may be comprised of cotton, fiberglass, plastic, mylar, bubble wrap filled with a greenhouse gas or air, burlap, black and white poly, polyester, bamboo, papyrus, or any material which may be a suitable insulator/reflector of heat and infrared energy.

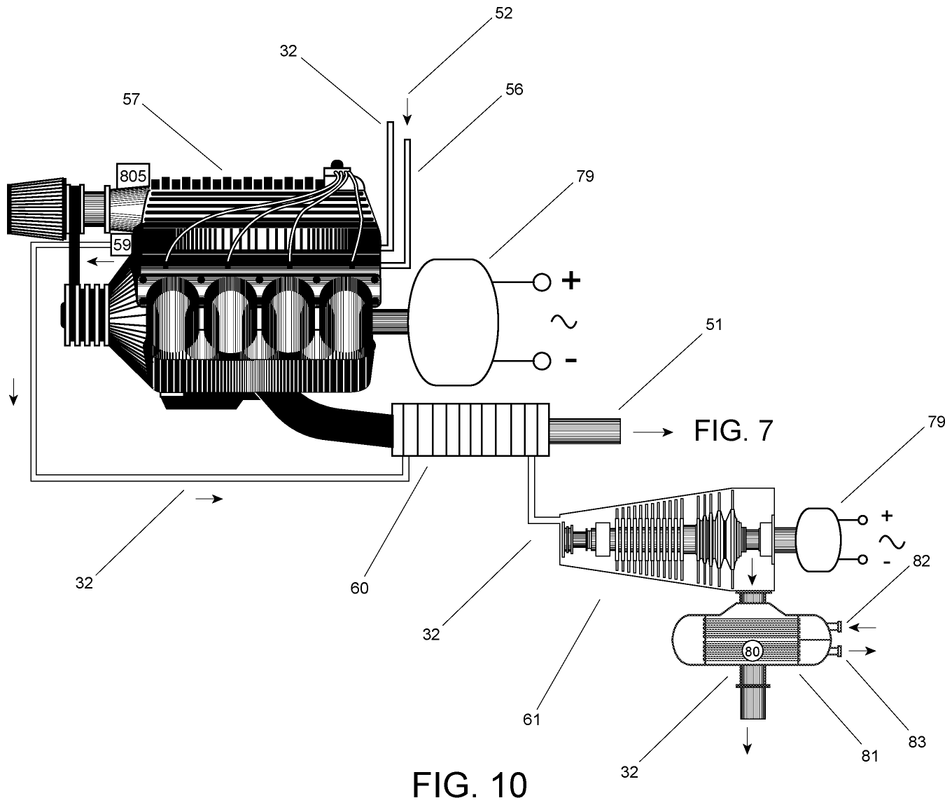

During the summer months it may be desirable to grow crops which thrive in high heat and high light conditions. Also, some crops such as cannabis require a reduction in the photoperiod to induce flowering from a vegetative state. As such, the use of the night-time insulating system described in FIG. 4A-4B may serve to darken the greenhouse before the sun has set by activating the motorized rollers 24, as to artificially reduce the photoperiod. However, it should be known that this invention is directed towards 24 hours of light to maximize productivity, and the use of plants which are genetically suited for 24 hour light exposure in a day. Once the sun has set, the motorized rollers 24 may withdraw or partially withdraw the insulating blankets 23 to facilitate proper cooling of the greenhouse 1, the water 5 in the water reservoir 12, and ultimately the steam turbine condenser 80 depicted in FIG. 10.

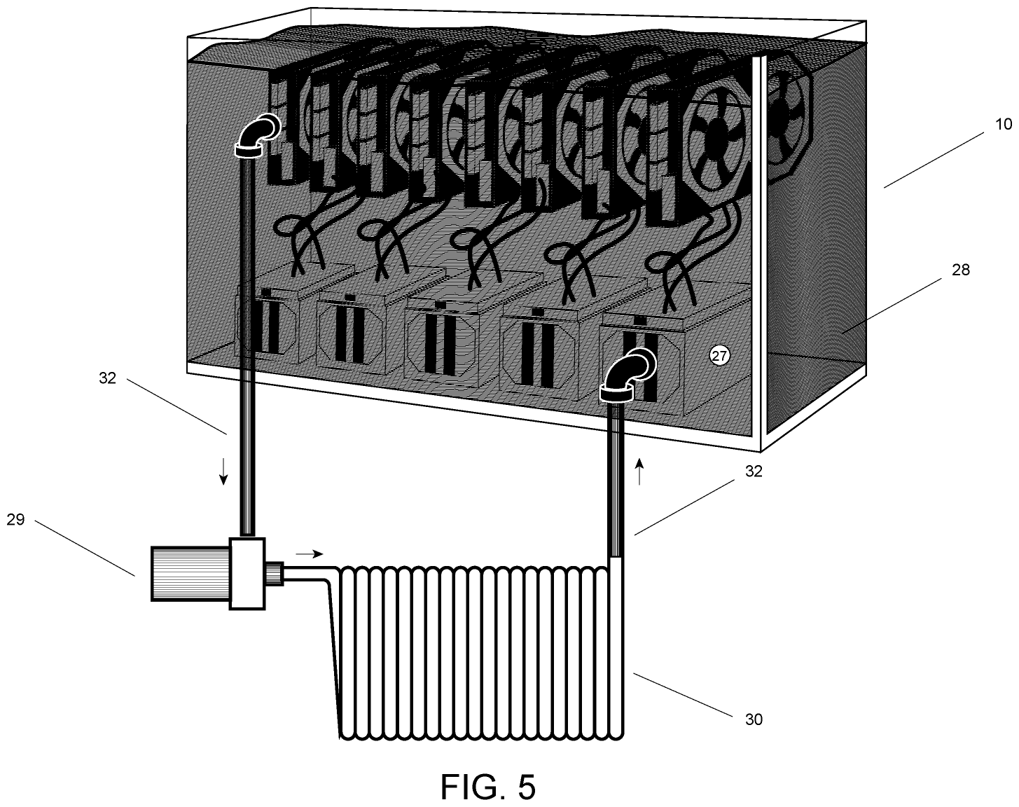

FIG. 5 depicts a plurality of cryptocurrency mining rigs 27 that may be comprised of several graphics processor units (GPU's), a motherboard, a central processing unit (CPU), memory, hard drive or solid state drive, power supply (PSU), and cabling on a mining rack. Alternatively, cryptocurrency may be mined with custom-built application specific integrated circuitry (ASIC) computer, which is designed to mine specific types of cryptocurrency. However, for the purpose of this invention, any large group of computers such as a server farm, a render farm, or any type of computer system with high waste heat, or essentially anywhere waste heat is available may be used within the boundaries of the invention.

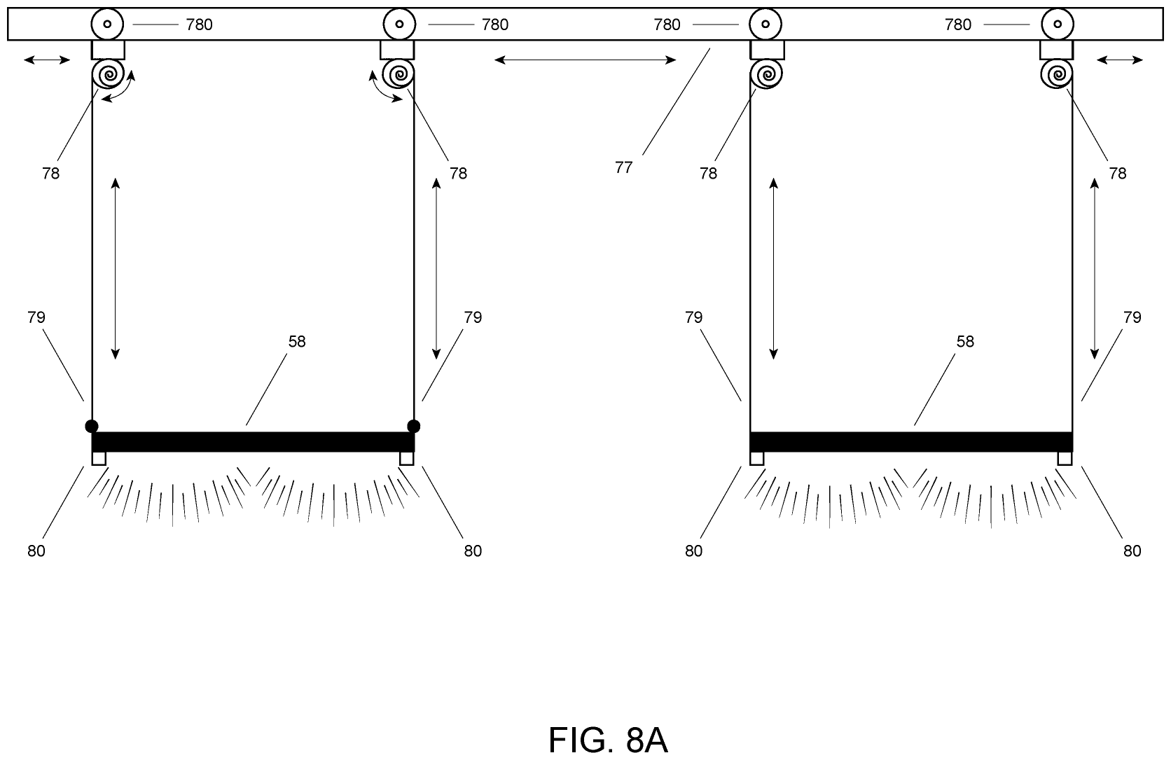

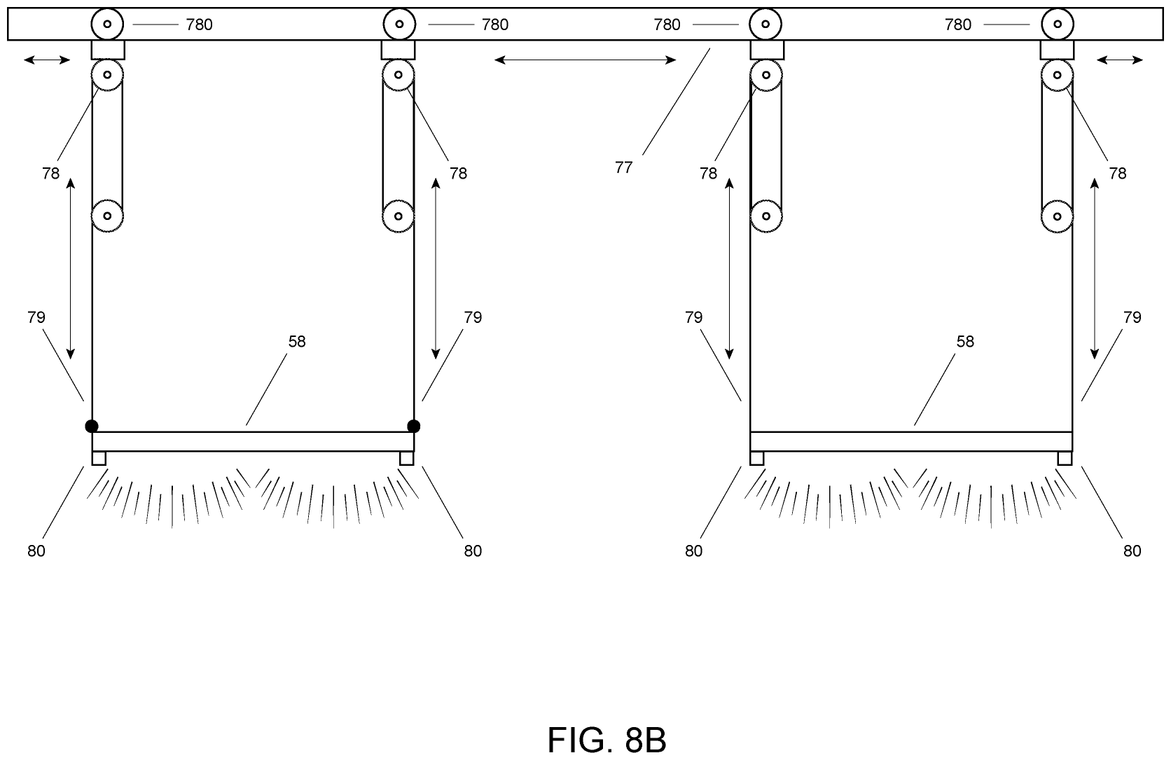

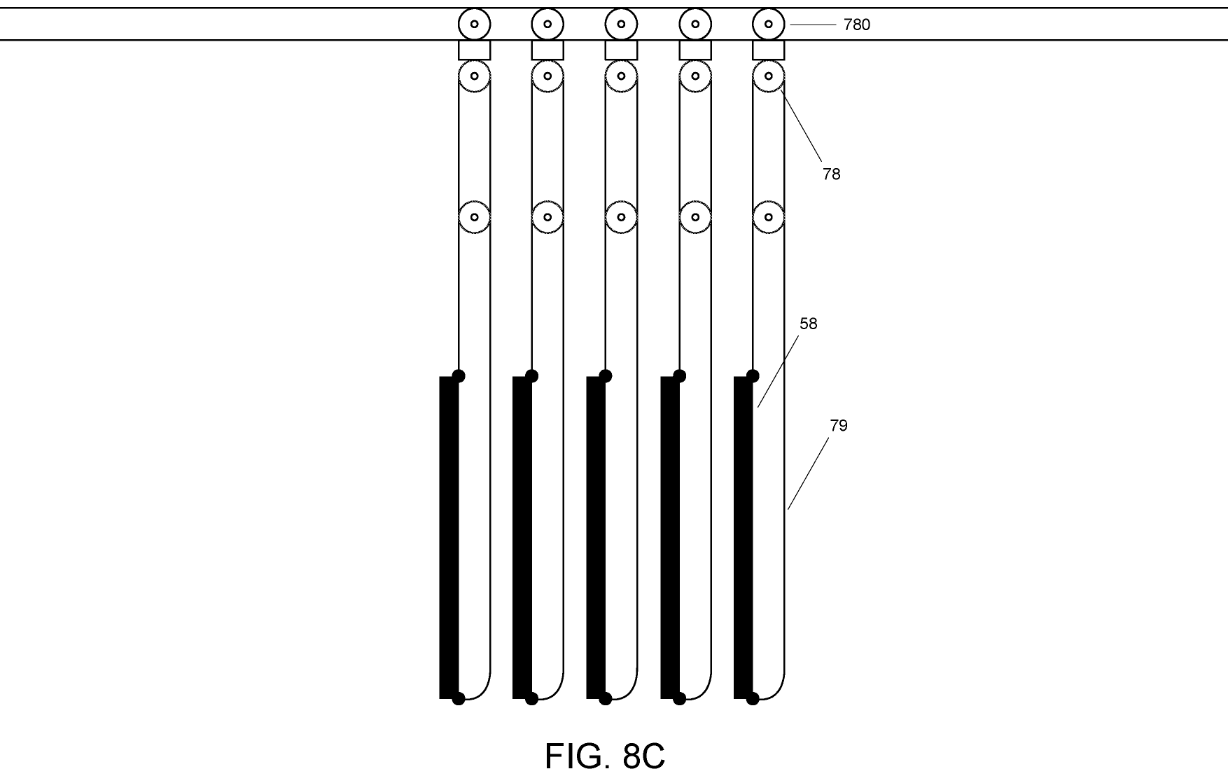

Normally, several fans remove the heat from the cryptocurrency mining rig 27, but in this particular example the fans are either disabled or removed entirely and the cryptocurrency mining rig is emersed in a bath of mineral oil 28 within. Recirculating pump 29 circulates the mineral oil from a liquid tight container 101 to the heat exchanger 30 (which is also depicted in FIG. 2) through insulated tubing 32, wherein heat is transferred from the mineral oil 28 to the heat sink 31. In a variation, air cooled cryptocurrency mining rig 27 may vent heat through a hot airline 51 depicted in FIG. 8, and the hot airline 51 may be directed into the greenhouse 1. Any type of suitable pump may be utilized as a recirculating pump 29. Any type of suitable non-ionic fluid may be used to submerge the cryptocurrency mining rig 27. Such examples are mineral oils, silicone oils, and polyethylene oils. Alternatively, an ionic fluid such as water or mercury may be used in conjunction with a heat exchanger. Often these heat exchangers for electronics can be positioned in direct contact with the computer processors.

Returning to FIG. 1 and FIG. 2, a separate auxiliary heat sink 43 may be utilized to store excessive heat which is too hot for the cultivation of plants and animals. This portion of the heat sink may be surrounded by an insulated wall 7 from the growth chamber 17 and irregular shaped rocks 5, as to provide means of storing heat which is at a higher temperature than what is suitable for plant and aquatic animal growth. In a variation, the auxiliary heat sink 43 may be physically located separately from the primary heat sink 31. In FIG. 1 and FIG. 2., the greenhouse 1 is depicted with the auxiliary heatsinks 43 positioned near and fluidly connected to heat inputs, which may allow a higher thermal capacity of the overall heat sinks, by having areas which are much hotter than which the plants and animals can tolerate. Irregular shaped rocks 5 within the auxiliary heatsink may heated to hundreds or even thousands of degrees Celsius. Further, hot water from the auxiliary heat sink 43 may redirected to a concentrated solar array 333 for reheating, or be heated again by engine exhaust through a heat exchanger 60 as depicted in FIG. 10. In another embodiment, geothermal heat is circulated or otherwise heat exchanged with the water within the auxiliary heat sink 43 before the resulting steam is directed into a steam turbine 61, discussed later in FIG. 10. Heat may be slowly released by a valve and thermostat (not shown), but much heat will simply flow into the heat sink from the auxiliary through slow conduction from the insulated walls, and positive pressure displacement through an opening. The opening may be regulated by a valve, and the valve type may be of any type described. In another embodiment, any type of suitable valve can be used. In general terms, a valve is a device which limits, controls, or regulates the flow of a liquid or a gas. I another embodiment, the auxiliary heat sink may be located directly below the primary heat sink as a new layer, wherein the auxiliary heat sink may be capable of storing much high temperature water greater than 100 degrees Celsius, which can also be diverted through a concentrated solar array 333 and heated back into steam, which then circulates back to steam turbine 61.

Steam turbines 61 come in different types and all should be presumed to be within the scope of this invention. Condensing, passout, condensing, and back pressure may all be used. Steam turbines 61 may also be multi-stage, which may increase their thermal efficiency. During each stage, steam may be reheated by waste heat from the internal combustion engine 57 including the turbocharger, engine exhaust, and engine coolant, from a geothermal source, from the cryptocurrency miners or computer equipment, from concentrated solar array or panels 333, or any other heat source such as an industrial process.

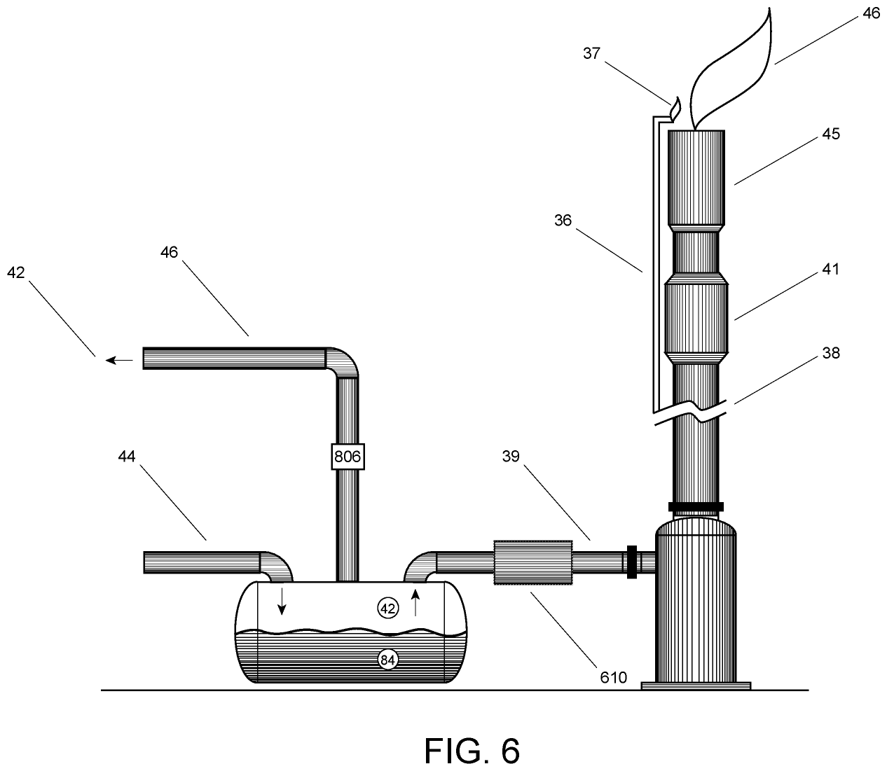

FIG. 6 is a depiction of a flare gas 42 configuration, where an oversized knockout drum 40 may be used to separate oil and gas that may be provided by a purge line 44 from an industrial process, while providing a buffer storage for an inconsistent flow rate of flare gas 42. Alternatively, a secondary gas storage counter may supplement or replace the oversized knockout drum 40. Flare gas 42 may flow from the oversized knockout drum 40 through an overpressure valve 610 to a flare header 39 and into a flare stack 38. The flare stack 38 me be comprised of a flashback preventer 41 near the top of the flare stack 38, where the flare tip 45 may be located. A flame 46 may often be seen on the top of a flare stack 38, which may be ignited by a pilot flame 37. Natural gas from a fuel supply line 36 may keep the pilot flame 37 continually ignited.

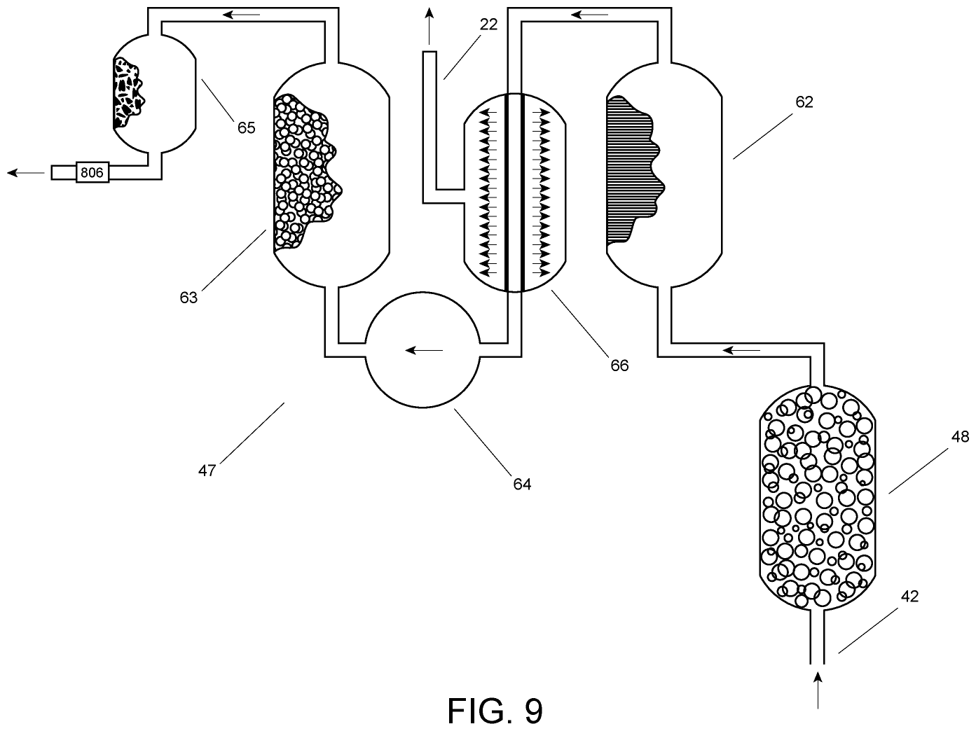

In a modified configuration, the oversized knockout drum 40 may be connected to a gas line 46 that connects to a flare gas filter 47 shown in FIG. 9. The gas line 46 may be comprised of a pressure sensor and/or a flow meter 806. The pressure sensor and/or flowmeter 806 depicted in FIG. 6 may meter the flow of unfiltered flare gas. Flow meters may be Coriolis type, differential pressure meters, mass flow meter, inertial flow meter, magnetic, multiphase, ultrasonic, vortex, or any other type. A pressure sensor may be piezoresistive, differential, anti-corrosive, strain gauge, chemical vapor deposition, variable capacitance, sputtered thin film pressure sensor, or any other type. The pressure sensor and/or flowmeter 806 depicted in FIG. 9 may meter the flow of filtered flare gas. A plurality of pressure sensor/or flow meters 806 may be used, such as one at the input and the other at the output of the filtration system depicted in FIG. 9. The difference in readings between the filtered and unfiltered flare gas from the two relative pressure sensors and/or flowmeters 806 may allow a control system or a person to calculate flare gas purity. The flare gas filter 47 may remove hydrogen sulphide from the flare gas 42 by deacidification, absorption, or other means. In the example given, flare gas 42 is passed through a solution of sodium hydroxide 48, which may convert hydrogen sulphide into a sulphur salt. Any hydroxide including potassium hydroxide may also be used, as well as Calcium hydroxide, or any other suitable material which reacts with carbon dioxide and forms a solid or otherwise ionizes into water solution. A water scrubber 62 may also filter flare gas 42 of carbon dioxide and hydrogen sulphide. Alternatively, the carbon dioxide may be separated by membrane and diverted to use in the greenhouse 1. A silica gel filter 63 may remove water vapour from the flare gas 42. An iron sponge filter 64 may remove carbon dioxide and traces of hydrogen sulphide from the flare gas 42. An activated carbon filter 65 may remove hydrogen sulphide from the flare gas 42. Carbon dioxide may be separated by a membrane 66 within the flare gas filter 47 shown in FIG. 9 and the carbon dioxide separated through carbon dioxide gas line 22. Returning to FIG. 1, purified carbon dioxide may be directed into the greenhouse 1 through carbon dioxide gas line 22 from the membrane 66 depicted in FIG. 9. Flow of the carbon dioxide may be regulated by an on/off gas valve 21. The on/off gas valve 21 may be controlled by a carbon dioxide monitor 20 located inside the greenhouse 1. The on/off gas valve 21 may be of any type described in this document, or any other suitable type. The carbon dioxide may be absorbed by photosynthesis into the greenhouse plants 19. The on/off gas valve 21 may be substituted with a variable output valve, or any other type of valve which can regulate the flow of carbon dioxide into the greenhouse 1. The carbon dioxide monitor 20 may be substituted with a timer 18. The carbon dioxide monitor 20 may provide information to an environmental control system (not shown), which may control the on/off gas valve 21. Essentially the carbon dioxide monitor 20 may regulate the flow of carbon dioxide into the greenhouse 1.

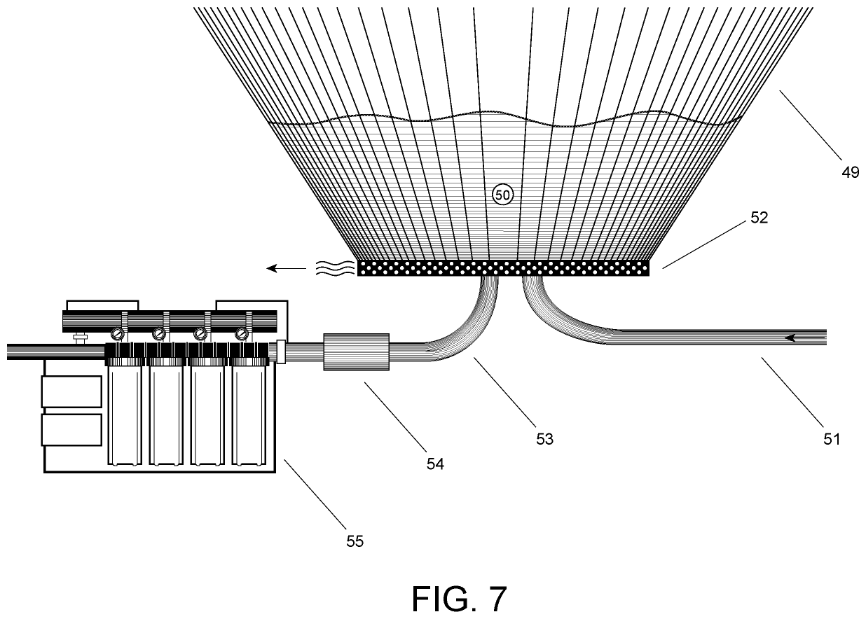

FIG. 7 depicts a water collection device comprised of a open top hopper 49 filled with water 50. The water 50 may have been collected by the rain falling into the hopper 49. Alternatively, a conveyor belt or screw auger (not shown) may provide water to the hopper 49. The hopper 49 may have a perforated heat exchanger 52, which allows heated water to drain into a water collection line 53. Alternatively, any type of heat exchanger may be used. The hopper 49 may be substituted with a barrel, a trough, a plastic container, or any other device intended to receive snow, ice, and/or water.

Hot air line 51 may connect to a perforated heat exchanger 52 located on the bottom of the hopper 49. Hot air line 51 may direct engine exhaust from the electrical generator 56 through the perforated heat exchanger 52. In another embodiment, hot air from cryptocurrency mining equipment or steam may be directed directly onto the water 50. The water may flow through the water collection line 53. A high-pressure water pump 54 may boost the pressure of the water in the water collection line 53. The water under pressure may then be provided to a water filtration system 55, which may filter the water of impurities. Any other type of suitable pump may be substituted or supplemented. The water filtration system 55 may be comprised of reverse osmosis, charcoal, zeolite, deionizer, particle, or any other type of water filtration system. As a variation of the invention, the hot air line may pass through a heat exchanger (not shown) to heat water obtained from any source, such as a well, lake, or river. Warm water may flow faster through a water filtration system 55 than cold water. The resulting water described in this paragraph and depicted in FIG. 7 may be fed or otherwise provided into the water input 9 shown in FIG. 2, and the water may become contained in the greenhouse reservoir 12.

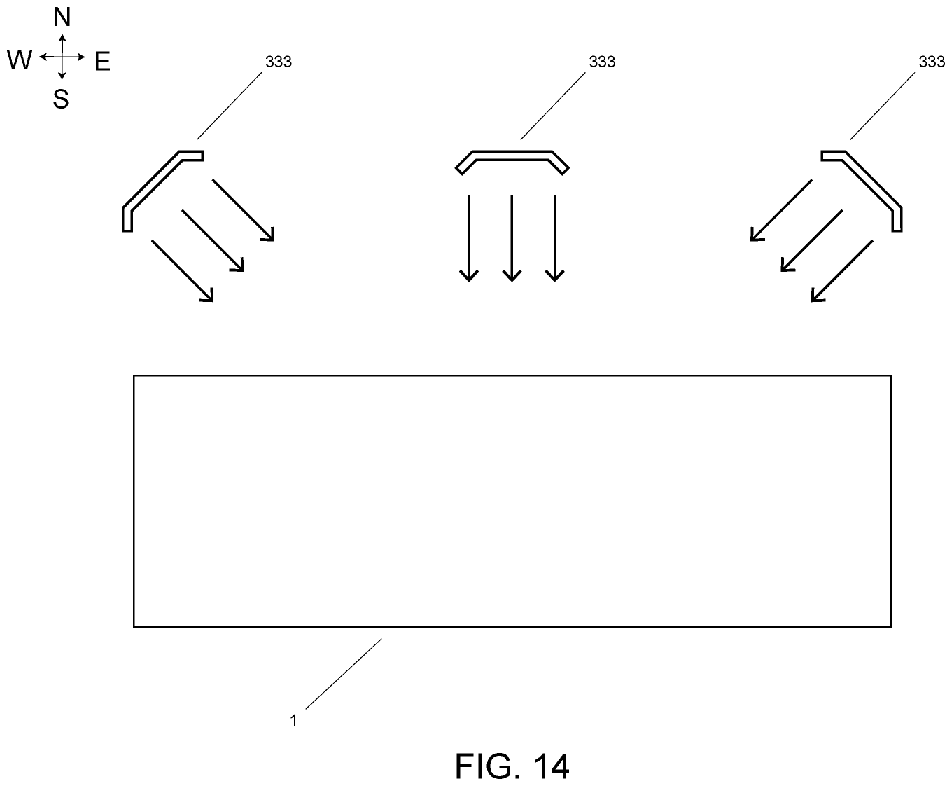

There may be times such as in the summer when the apparatus described within has an excess of heat. During this time, it may be economical to utilize the waste heat in other ways. For one example, waste hot water from a steam turbine may be recycled through a concentrated solar array described later in this document in FIG. 14, which may cause the water to again transform into steam. The steam may then be circulated into the steam turbine 61, and thus generate electricity such as shown as steam turbine 61 in FIG. 10.

FIG. 8A is a depiction of an automatic artificial light moving system. Light rail 77 may be comprised of a track motor 780, which may move artificial light fixtures 58 from side-to-side in greenhouse 1. This system is well known for use in indoor growing environments. But in this inventive configuration, motorized spools 78 may raise or lower any corner of artificial light fixtures 58 by retracting or extending conductive cables 79 on the motorized spool 78. Alternatively, any device which raises or lowers the artificial light fixtures 58 may be used for the purpose of this invention. Electrically conductive cables 79 may carry electricity to artificial light fixtures 58 through the light moving system, thereby a conductive cable 79 is used to raise and lower the artificial light 58 and provide electricity to the artificial light 58 simultaneously. Proximity sensors 80 positioned on the artificial light fixtures 58 may provide information which is used to control motorized spools 78, to maintain a calculated distance from the plant canopy. Proximity sensors 80 have been previously defined in this document. An analog circuit may control motorized spools 78, or control decisions may be made by a microprocessor (not shown). As such, as track motor 780 moves artificial light fixtures 58 back and forth across the greenhouse plants 19 within the greenhouse 1, proximity detection from proximity sensors 80 provide information which control the movement of motorized spools 78 to raise or lower the artificial light fixtures 58. A proximity sensor 80 may be positioned in each of the four corners or more, so that the artificial light 58 can be positioned in three dimensional angles. This operation may allow even distribution of light throughout the greenhouse 1 at all times during lighting operations.

FIG. 8B depicts a variation of the invention, wherein motorized pulleys 800 may substitute or supplement the motorized spools 78. Alternatively, any device which raises and lowers the artificial lighting fixture 58 may be employed. FIG. 8C provides yet another example, wherein the artificial lighting fixtures 58 have taken extreme angles for storage or to provide lighting for vertical farming structures at diagonal angles. In this example, a highly rigid conductive cable 79 may be utilized to allow artificial lighting fixtures 58 to rest or otherwise remain inactive in a fully vertical position or near vertical. During times of daylight hours, the artificial light fixtures 58 may be positioned in a manner which lessens the obstruction or shading of natural sunlight onto the plants. As to maintaining a fully vertical position of the artificial lights 58, a highly rigid and spring like conductive cable may be used.

FIG. 10 is a depiction of a co-generation system of electricity, where filtered flare gas 52 may be provided by a gas line 56 to an internal combustion engine 57. Alternatively, raw flare gas may be used. The gas line 57 may be comprised of metal, plastic, Teflon, ceramic, cement, epoxy, or any other suitable material. Pressure sensor and/or flowmeters 806 depicted in FIG. 6 and FIG. 9 may provide information to a microprocessor or an analog circuit. The microprocessor may be part of a programmable logic controller (PLC), a personal computer system, a network, standalone, or any other type of suitable computer system. The information received Pressure sensor and/or flowmeters 806 may be used to control the throttle of internal combustion engine 57 with a throttle controller 805. Throttle controller 805 may be comprised of an armature to control the throttle or may operate electronically. The internal combustion engine 57 may operate with the use of carburation, fuel injection, turbocharging, supercharging, or any other suitable means of providing fuel and oxygen into the internal combustion engine 57. The internal combustion engine 57 may be piston, rotary, twostroke, four-stroke, six-stroke, spark ignition, compression ignition, Otto cycle, dual cycle, diesel cycle, and contain any number of pistons. Alternatively or in addition, a plurality of internal combustion engines 57 may be used. During times of high flare gas output several internal combustion engines 57 may be used, and during times of low gas output only one or a portion of internal combustion engines 57 may operate. In another embodiment, the internal combustion engine 57 may be substituted or supplemented with a fuel cell or a gas turbine. The crankshaft of an internal combustion engine 57 may turn an electrical generator 79 that may provide electricity to cryptocurrency mining rigs 27, and electricity to any equipment in greenhouse 1 such as artificial light fixture 58. Alternatively, the generated electrical energy may be stored in a battery for later use. For example, electricity generated during the day may be stored for use at night in a battery to power artificial lighting. Water from any of the sources described in this document or elsewhere may be pumped into the internal combustion engine as a coolant, wherein thermostat 59 may open or close to regulate the temperature of the internal combustion engine 57. Alternatively, a variable speed pump may be used to circulate the hot water. The hot water may then pass through an engine exhaust heat exchanger 60, where the water is heated further into steam.

The steam that may be generated from the internal combustion engine 57 exhaust (and turbocharger) may then pass through and turn a steam turbine 61 that turns an electrical generator 79. The electrical generators 79 may provide electricity for the cryptocurrency mining rigs 27, and any equipment in greenhouse 1, or any other equipment such as batteries. The steam turbine 61 may be further comprised of a condenser 81, which may lower the pressure and temperature of the steam and thus increase the efficiency of electrical generation. The condenser 81 may be comprised of heat exchanger coils 80, a water input 82, and a water output 83. The condenser 81 may be provided water through the water input 82 from water output 9 depicted in FIG. 2. The water may be circulated by a pump (not shown). Any type of suitable pump may be used. The hot water from the water output 83 of the condenser 81 may recirculate to the water input 10 depicted in FIG. 2. The waste steam may then travel down insulated tubing 32 and flow into the greenhouse reservoir through steam input 14 depicted in FIG. 1. The insulated tubing 32 may be comprised of metal, plastic, ceramic, stone, or any suitable material. As an alternative, steam may be provided directly from any source, and converted into electricity from the steam turbine 61 and an electrical generator 79, with the internal combustion engine 57 omitted. In another embodiment, the heated water being released by the thermostat 57 may be circulated through a heat exchanger physically connected to the internal combustion engine 57 turbocharger (not shown).

Returning to FIG. 10, an increase in throttle may result in an increase in electrical output from generators 79. An environmental control system, a microprocessor, an analog circuit may turn on some of or all of the artificial lighting systems 58. An increase in throttle may result in more artificial lighting 58 being turned on, while a decrease in throttle may result in some artificial lighting 58 being turned off. The turning on/off of lights may be triggered off by a decrease in voltage, and artificial lights 58 may be triggered on from an increase in voltage. This on/off system of the artificial lighting 58 may allow capitalization and use of the inconsistent fluctuations of flare gas 52 output. Alternatively, a plurality of internal combustion engines 57 may shut on/off while a plurality of artificial lighting 58 may turn on/off simultaneous to the internal combustion engines 57. The electrical generators 79 may output alternating current (AC) or direct current (DC). In one embodiment, the electrical generators 79 may output both +12 volts and −12 volts. In another embodiment, the electrical generators 79 may output only 12 volts.

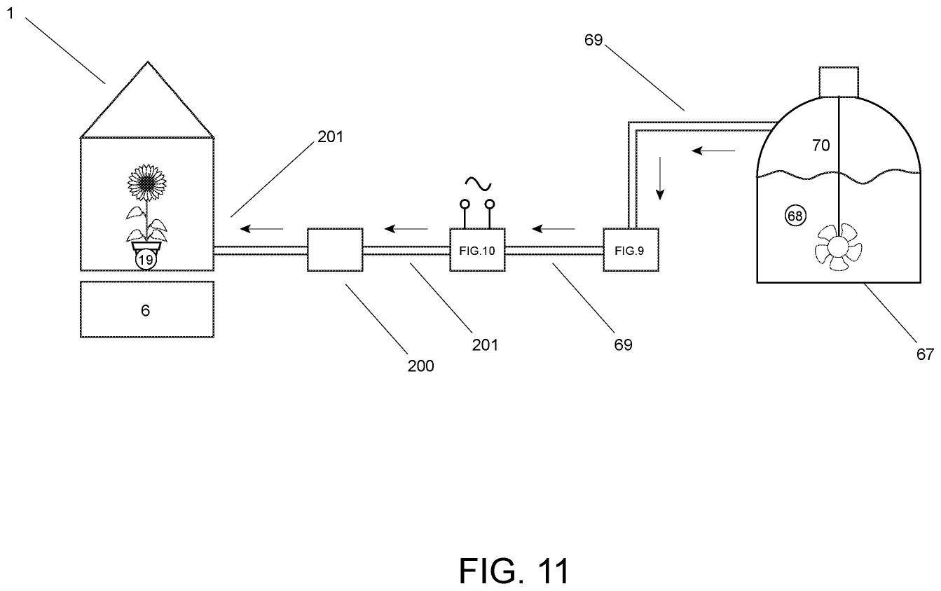

FIG. 11. is a depiction of a modified biogas facility, where anaerobic digester 67 may be configured to digest organic material 68 in conditions which lack oxygen. Anaerobic digesters 67 inherently limit the amount of oxygen the decaying organic material 68 is exposed to, thus stimulating the generation of methane over carbon dioxide. Anaerobic digesters 67 can be comprised of numerous substances including stone, concrete, plastic, metal such as stainless steel, galvanized steel, aluminum, treated wood or natural fibre, or any other suitable material, and may have an agitator or stirrer to mix the organic material within. Alternatively, a pump may be used to circulate organic material, a water wheel, a vibrator, any mechanism intended to agitate or move the decaying organic material 68. Such anaerobic conditions lacking oxygen may favour the production of methane over carbon dioxide. The produced biogas 70 may flow through biogas pipe 69 into a filtration system depicted in FIG. 9, and then the filtered biogas 70 may flow along biogas pipe 69 into internal combustion engine 57 (FIG. 10). The biogas 70 may then be combusted in a co-generation apparatus depicted in FIG. 10. The decomposed organic material 68 shown in FIG. 11 may be dissolved into reservoir water 6 and used to fertilize greenhouse plants 19. Other sources of water may also be used to dissolve organic material 68 shown in FIG. 11 and used to fertilize greenhouse plants 19. Further, FIG. 11 depicts the waste combusted gas from FIG. 10 flowing through gas pipe 201 to waste gas filter 200, and then into greenhouse 1. The growth rate and yield of greenhouse plants 19 may be increased as a result of high carbon dioxide levels in greenhouse 1.

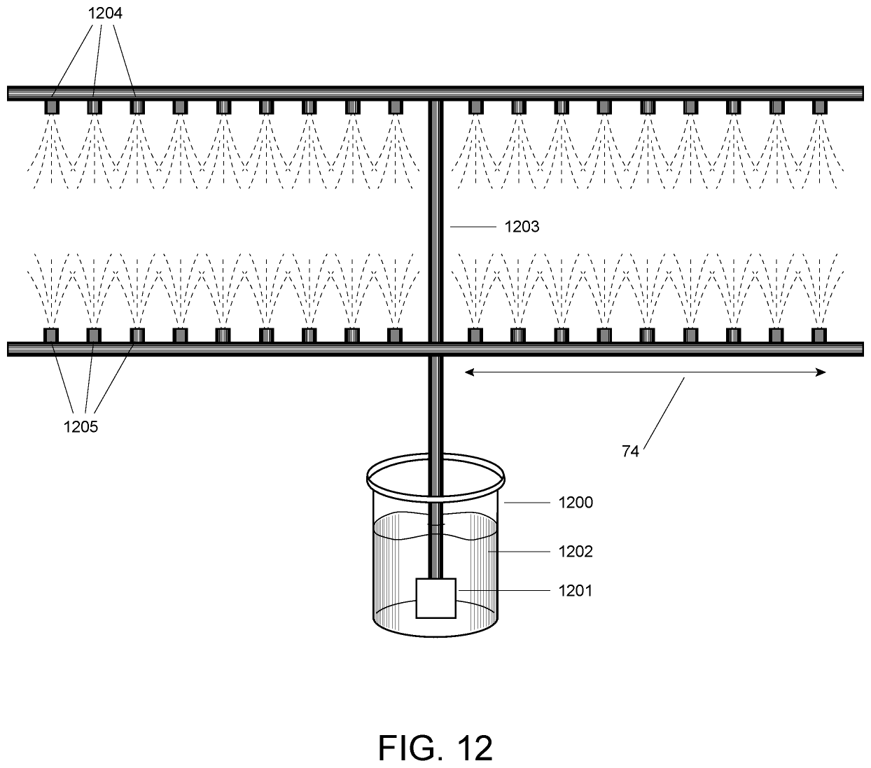

FIG. 12 is a depiction of a natural pesticide dispensing system within greenhouse 1, wherein pesticide tank 1200 may contain a hydrogen peroxide solution or a pyrethrum solution 1202. Pyrethrum is a natural pesticide derived from chrysanthemums or synthesized, and may be effective at killing many forms of insects. However, pyrethrums may generally kill only adult and larvae insects, whereas insect eggs may not be harmed by a pyrethrum solution 1202. As such, regular dispensing of pyrethrum solution 1202 may be necessary to kill all insects in a vulnerable growth stage and prevent further egg laying.

Submersible pump 1201 may pump pyrethrum solution ethrum pipe 1203 and into pyrethrum manifold 74. The pressure within manifold 74 may cause a fine mist of pyrethrum solution 72 to be sprayed from spray nozzles 75. Alternatively, any pesticide which is natural and biodegradable may be utilized in the misting system. A timer 18 may turn on submersible pump 76 for very brief but regular intervals. Alternatively, pyrethrum solution 72 may be in a canister under pressure and may be released by a valve (not shown). The chrysanthemums may be grown inside of greenhouse 1 as greenhouse plants 19 and pyrethrum solution 72 may be extracted from said chrysanthemums. The greenhouse may be constructed in such a manner as to limit the amount of pyrethrum that can enter the greenhouse reservoir 12, as pyrethrums may be toxic to some aquatic animals. As such, other suitable pesticides, may be dispensed by the invention including fungicides, miticides, insecticides, and rodenticides. Repellants may also be dispensed to deal with pests, for example it may be better to deter rat infestation with repellants, not only for humanitarian reasons but also because it negates the need to dispose of dead carcasses.

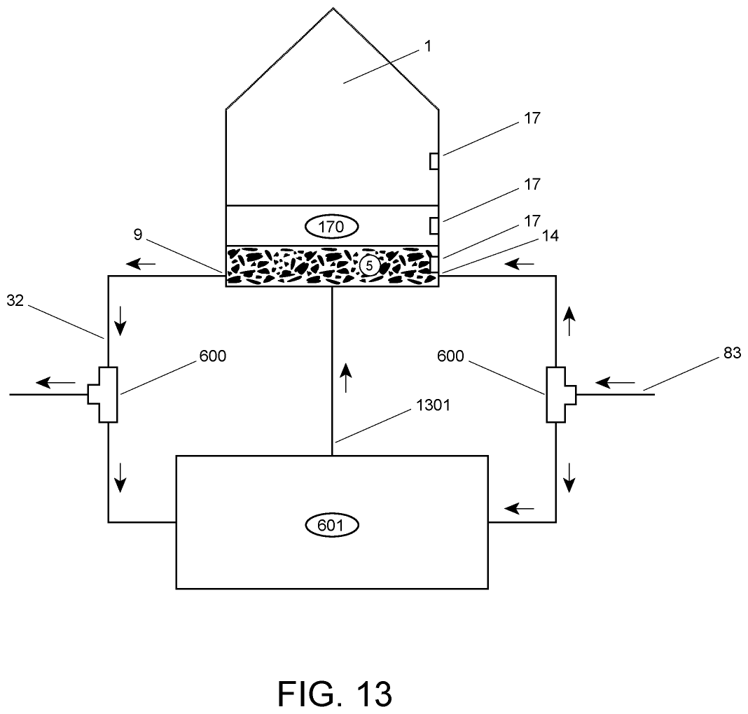

FIG. 13 depicts a bypass geothermal radiator 601 designed to remove excess heat from the system. During conditions where thermostats 17 detect too much heat in the greenhouse 1, growth chamber 170, or irregular shaped rocks 5, bypass valves 600 may open or close to redirect water from greenhouse water output 9 and/or steam condenser water output 83 into a large, subterranean radiator 601. In some embodiments, multiple subterranean radiators may be used. In another alternative, the greenhouse water input 10 is redirected by a bypass valve 600 into the subterranean radiator 601. A bypass valve 600 may be a combination of two or more valves, wherein one valve opens and one valve closes to redirect water or steam flow. Alternatively supplementary, a cooling tower may be used to dissipate excessive heat. The subterranean radiator 601 may allow the water reservoir to dissipate heat and control the temperature of the water 6 within the reservoir 12. In one embodiment, the subterranean radiator 601 is replaced or supplemented with an air-cooled radiator (not shown). In another embodiment, the liquid cooled cryptocurrency mining equipment depicted in FIG. 5 is cooled with an external radiator, such as a typical liquid-to-air heat exchanger. In another embodiment again, hot air may be directed into the greenhouse 1 from the cryptocurrency mining rig, and that air may be re-directed by an air bypass valve (not shown) to the outside.

FIG. 14 is a depiction of concentrated solar array panels 333, which may be positioned to reflect light into the greenhouse 1. Concentrated solar involves using large reflective surfaces to aim light in a particular direction. Each individual concentrated solar array panel may rotate on a motorized system to concentrate light in a particular direction, and those reflective panels 333 may be rotated based on manual adjustment, adjustment using cameras, adjustment using lasers, and adjustment using sonar or radar. Adjustments of reflective angles may also be based on mathematical calculations, or any other method known. However, conventional concentrated solar will concentrate the light into one spot, while this invention may distribute the light evenly amongst the plants. Alternatively, light may be directed into an area of type of plants which favour higher light. A winter greenhouse may have the concentrated solar panels 333 positioned on the north side in the northern hemisphere, as to provide light for the backside of the greenhouse. The concentrated solar array panels 333 may be in an elevated position, as to more effectively reflect light in a downward direction towards the greenhouse. The elevated position may be on a hillside or may involve elevating mirrors on poles. During times of excess heat in the greenhouse, concentrated solar array panels 333 may redirect the light onto black or otherwise light absorbing pipes which circulate water or another type of liquid coolant. Those pipes may be heated to boil the water, and the steam may be further used to generate electricity. During periods of strong winds, panels may turn into the wind direction as to minimize resistance and thus may avoid damage from the wind.

A system is also disclosed to minimize carbon footprint to the end consumer. In some circumstances, the greenhouse 1 may be within reasonably proximity of many residential and commercial areas. As such, this area may serve well for direct distribution of fresh fruits, shrimp, and vegetables. Ideally, vehicles that distribute the food to the end consumer should be electric vehicles. Also, those vehicles may be driverless. End consumers may order fresh vegetables and fruits using a software application. Electric vehicles, including heavy duty electric trucks, may be used for distribution to a local distribution centre as well, wherein lighter electric vehicles may be used. As such, electric vehicles may be charged by the apparatus of FIG. 10, and electric vehicles may also serve as batteries described within for night time operations, and may be charged when superfluous amounts of electrical energy are available. As such, surplus electricity may always or less frequently be avoided being wasted.

During full sun operating hours, the concentrated solar array panels 333 may be concentrated on an area to produce steam. The steam may turn a turbine to generate electricity, and the condenser of the turbine may be cooled by the greenhouse water reservoir, the subterranean radiator, a cooling tower, the auxiliary heat sink, or by any other means.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. An apparatus for moving artificial lighting within an enclosed environment, the enclosed environment configured for growing at least one plant, the apparatus comprising:
a track positioned at least a portion across the enclosed environment configured for growing plants, the track configured to support artificial lighting;
at least one motor connected to the track, the motor configured for moving an artificial light along at least a portion of the track;
an artificial light, the artificial light configured to emit at least a portion of light towards the plant;
at least one device configured for at least one of raising and lowering an artificial light, the device configured for raising and lowering an artificial light connected to the track; and
at least one proximity sensor, the proximity sensor configured to detect a distance from the plant, the proximity sensor further configured to at least one of raise and lower an artificial light by engaging the device which at least one of raises and lowers the artificial light.

2. The apparatus of claim 1, the apparatus further comprising a plurality of devices configured for at least one of raising and lowering an artificial light, the plurality of devices configured for raising and lowering the artificial light in a manner which positions the artificial light in a diagonal position relative to the plant.
